(19) United States
(12) Patent Application Publication
(10) Pub. No.: US 2006/0080800 A1
(43) Pub. Date: Apr. 20, 2006

(54) Paint roller assembly

(76) Inventor: Sander Lye, Taipei (TW)

Correspondence Address: BACON & THOMAS, PLLC, 625 SLATERS LANE, FOURTH FLOOR, ALEXANDRIA, VA, 22314, US

(21) Appl. No.: 10/988,601

(22) Filed: Nov. 16, 2004

(30) Foreign Application Priority Data
Oct. 14, 2004 (TW) 93216364

(51) Int. Cl. B05C 17/02

(52) U.S. Cl. 15/230.11; 492/13; 492/19

(57) ABSTRACT

A paint roller assembly for paining the corner area between two abutted wall surfaces includes a main paint roller, which has a roller frame, a handle fastened to the roller frame, and a roller cover pivotally mounted on the roller frame for soaking and retaining paint and rotatable on the roller frame over a wall surface to apply retained paint to the wall surface, and a supplementary paint applicator, which has a body connectable to the roller frame of the main paint roller and an applicator element fastened to the body and located at a lateral side of the roller cover for soaking paint for application.

### BACKGROUND OF THE INVENTION

1. Field of the Invention

The present invention relates generally to a paint roller and more particularly, to a paint roller assembly, which comprises a main paint roller and a supplementary paint applicator.

2. Description of the Related Art

FIG. 1 shows a conventional paint roller A, which comprises a roller frame A1, a handle A2, and a roller cover A3. The roller frame A1 is made by bending a metal wire rod into shape, having a first part A11, a second part A12 integrally extended from one end of the first part A11 and defining with the first part A11 a contained angle about 135°, and a third part A13 integrally extended from one end of the second part A12 remote from the first part A11 and defining with the second part A12 a contained angle about 45°. The handle A2 is made of plastics and fastened to the first part A11 of the roller frame A1 for the holding of the user's hand. The roller cover A3 comprises a cylindrical body A31 pivotally mounted on the third part A13 of the roller frame A1, and a covering A32 covered on the periphery of the cylindrical body A31 for soaking and retaining paint for application. When in use, the user holds the handle A2 and uses the covering A32 of the roller cover A3 to soak paint, and then move the roller cover A3 over the wall surface back and forth to apply paint to the wall surface.

The aforesaid design of paint roller is still not satisfactory in function. When painting the border area of one wall surface B abutting to a second wall surface C, the connecting area between the second part A12 and third part A13 of the roller frame A1 will be stopped against the second wall surface C. At this time, the covering A32 of the roller cover A3 cannot touch the border area of the first wall surface B, i.e., paint cannot be applied to the border area of the first wall surface B.

In order to eliminate the aforesaid problem, improved designs are developed and seen in U.S. Pat. Nos. 6,499,177, 5,613,264, 4,402,102 and 6,742,212. U.S. Pat. Nos. 6,499,177, 5,613,264 and 4,402,102 commonly disclose a corner paint roller comprised of a frame assembly, a hollow cylindrical paint roller cover for spreading a coating material, and an end cap assembly having a paint retaining material for attachment to the paint roller cover and the frame assembly. The corner paint roller of this design is still not satisfactory in function because the end cap assembly may contaminate the second wall surface when painting the first wall surface. U.S. Pat. No. 6,742,212 discloses a paint application apparatus used to apply paint along the edge of one surface but not on an adjacent surface. This design of paint application apparatus is comprised of a paint applicator roller cover, a shield, a handle, and at least one paint brush attached to the shield. This design of paint application apparatus has a complicated structure, resulting in a high manufacturing cost. Further, the specifically designed paint brush and shield are not applicable to regular paint rollers.

### SUMMARY OF THE INVENTION

The present invention has been accomplished under the circumstances in view. It is the objective of the present invention to provide a paint roller assembly, which is practical for paining the corner area between two abutted wall surfaces.

To achieve this objective of the present invention, the paint roller assembly comprises a main paint roller and a supplementary paint applicator. The main paint roller comprises a roller frame, a handle fastened to the roller frame, and a roller cover pivotally mounted on the roller frame for soaking and retaining paint and rotatable on the roller frame over a wall surface to apply retained paint to the wall surface. The supplementary paint applicator comprises a body, which has a mounting portion connectable to the roller frame of the main paint roller, and an applicator element fastened to the body and located at a lateral side of the roller cover for soaking paint for application.

### BRIEF DESCRIPTION OF THE DRAWINGS

FIG. 1 is a schematic view of a prior art paint roller, showing the paint roller is in use at a corner area of two abutted wall surfaces.

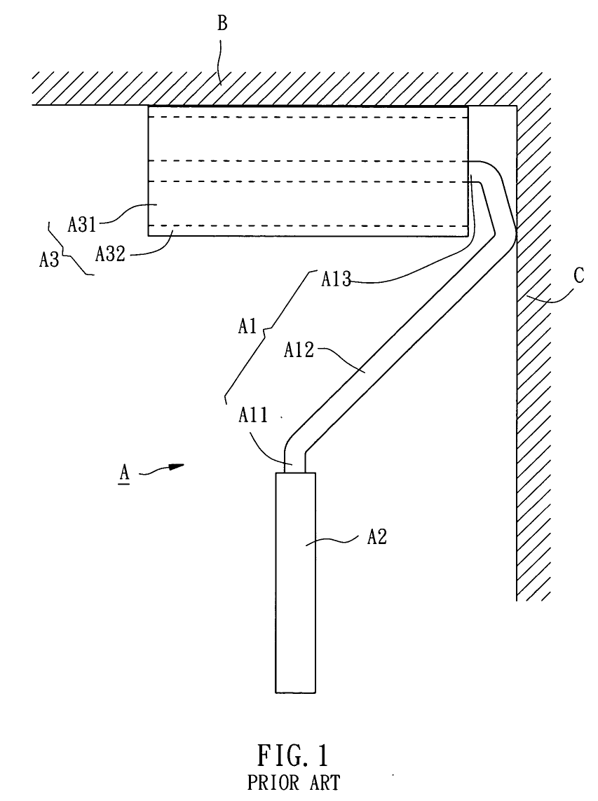

FIG. 2 is a front view of a paint roller assembly according to a first preferred embodiment of the present invention.

FIG. 3 is an exploded view of the paint roller assembly according to the first preferred embodiment of the present invention.

FIG. 4 is a schematic view of the paint roller assembly according to the first preferred embodiment of the present invention.

FIG. 5 is a front view of a paint roller assembly according to a second preferred embodiment of the present invention.

### DETAILED DESCRIPTION OF THE INVENTION

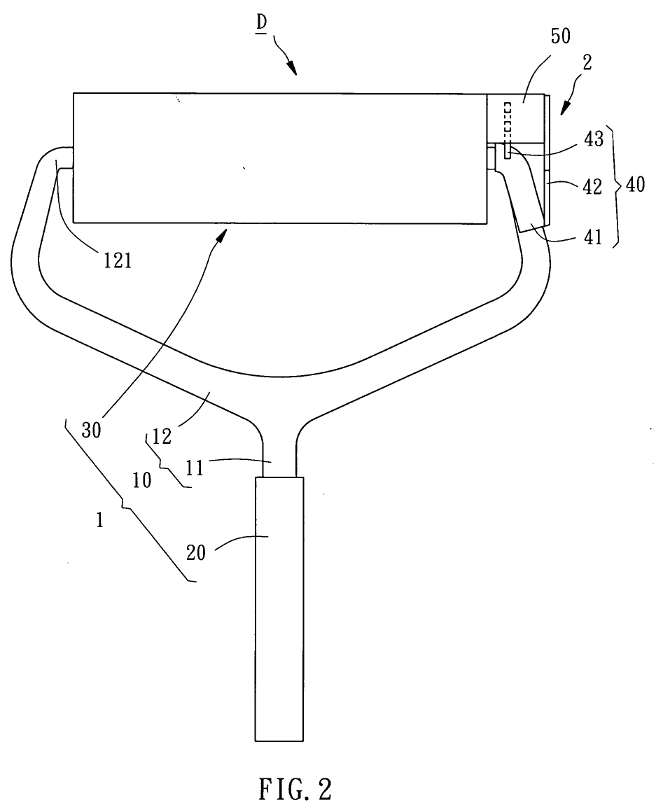

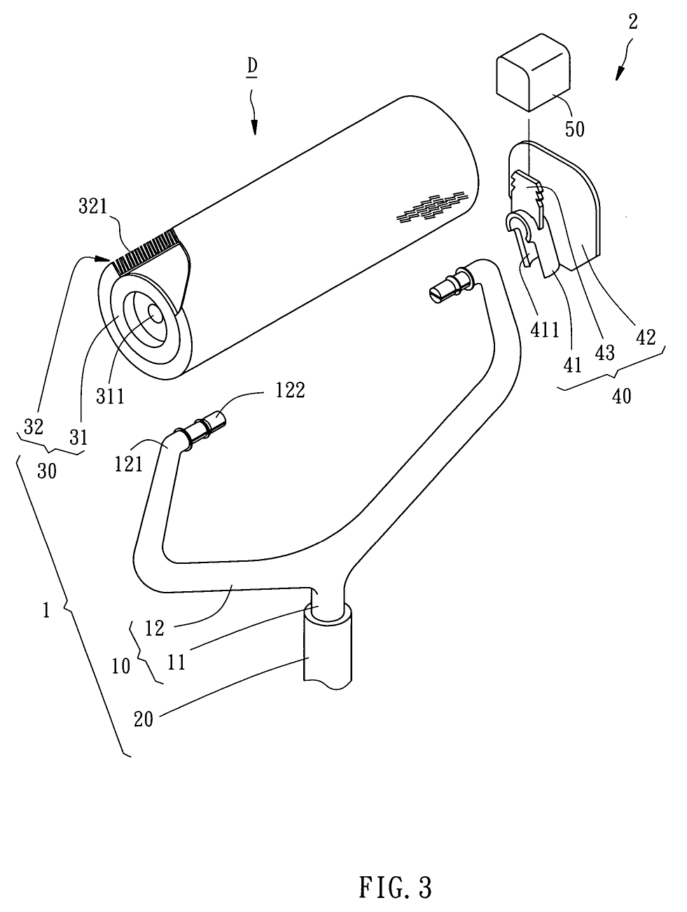

Referring to FIGS. 2 and 3, a paint roller assembly D in accordance with the first preferred embodiment of the present invention is shown comprised of a main paint roller 1 and a supplementary paint applicator 2.

The main paint roller 1 comprises a roller frame 10, a handle 20, and a roller cover 30. The roller frame 10 is made of plastics, having a base 11 and two support arms 12 symmetrically outwardly extended from the base 11. The support arms 12 each have a rear (free) end terminating in an inwardly transversely extended bent 121 and then a pivot 122.

The handle 20 is made of plastics and fastened to the base 11 of the roller frame 10.

The roller cover 30 comprises a cylindrical body 31 and a covering 32 covered on the periphery of the cylindrical body 31. The cylindrical body 31 has a coupling hole 311 formed on each of the two distal ends and respectively coupled to the pivots 122 of the support arms 12 of the roller frame 10. The covering 32 has an outer felt layer 321 for picking up and retaining paint for application. Alternatively, the covering 32 can be formed of sponge or the like that can pick up and retain paint for application.

The supplementary paint applicator 2 comprises a body 40 and an applicator element 50. The body 40 comprises a mounting portion 41, a baffle 42, and a holder plate 43. The mounting portion 41 has a front side and a back side. The front side of the mounting portion 41 defines a coupling hole 411 fitting the contour of the bend 121 of each of the support arms 12 and selectively detachably coupled to the bent 121 of one support arm 12 of the roller frame 10. The baffle 42 and the holder plate 43 are arranged in parallel at the back side of the mounting portion 41. The holder plate 43 has two side edges serrated. The applicator element 50 is made of foamed material, sponge or the like that can soak and retain paint for application. Further, the applicator element 50 is fastened to the holder plate 43 of the body 40.

The coupling hole 411 of the supplementary paint applicator 2 is coupled to the bent 121 of one support arm 12 of the roller frame 10 of the main paint roller 1, keeping the supplementary paint applicator 2 secured to the main paint roller 1 with the applicator element 50 and the baffle 42 disposed at one lateral side of the roller cover 30. When installed, the distance between the baffle 42 and the roller cover 30 is greater than the distance between the applicator element 50 and the roller cover 30.

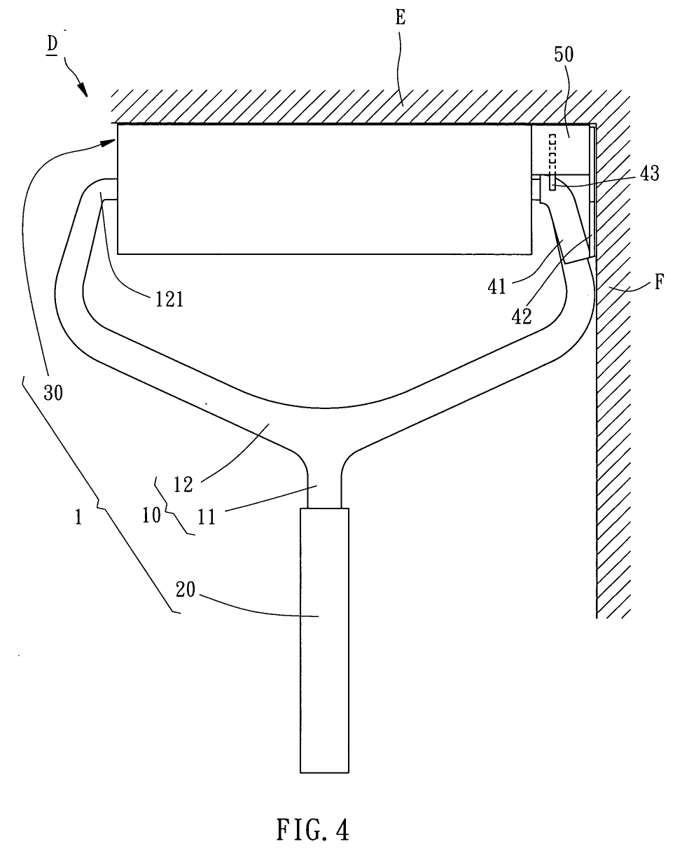

Referring to FIG. 4, when paining the border area of a first wall surface E abutting to a second wall surface F with the baffle 43 of the paint roller assembly D stopped at the second wall surface F, the covering 32 of the roller cover 30 and the applicator element 50 of the supplementary paint applicator 2 are pressed on the first wall surface E, and therefore the border area of the first wall surface E abutting to the second wall surface F are wholly painted with paint. Further, because the baffle 42 is stopped at the second wall surface F, it prevents touching of paint at the supplementary paint applicator 2 with the second wall surface F and guides smooth movement on the first wall surface E to evenly apply paint to the first wall surface E.

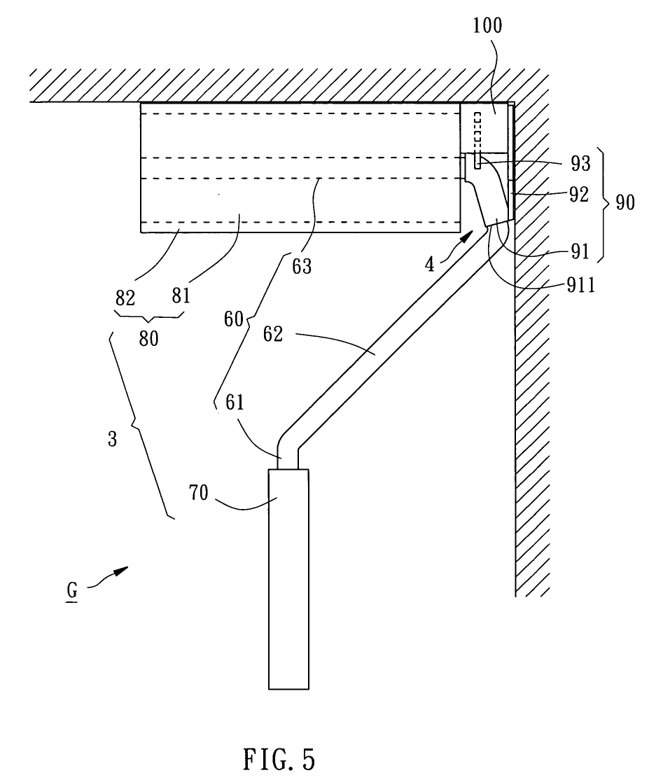

FIG. 5 shows a paint roller assembly according to the second preferred embodiment of the present invention. According to this embodiment, the paint roller assembly G is comprised of a main paint roller 3 and a supplementary paint applicator 4.

The main paint roller 3 comprises a roller frame 60, a handle 70, and a roller cover 80. The roller frame 60 is made by bending a metal wire rod into shape, having a first part 61, a second part 62 integrally extended from one end of the first part 61 and defining with the first part 61 a contained angle about 135°, and a third part 63 integrally extended from one end of the second part 62 remote from the first part 61 and defining with the second part 62 a contained angle about 45°. The handle 70 is made of plastics and fastened to the first part 61 of the roller frame 60 for the holding of the user's hand. The roller cover 80 comprises a cylindrical body 81 pivotally mounted on the third part 63 of the roller frame 60, and a covering 82 covered on the periphery of the cylindrical body 81 for picking up and retaining paint for application.

The supplementary paint applicator 4 comprises a body 90 and an applicator element 100. The body 90 comprises a mounting portion 91, a baffle 92, and a holder plate 93. The mounting portion 91 has a front side and a back side. The front side of the mounting portion 91 defines a coupling hole 911 detachably coupled to the connecting area between the second part 62 and third part 63 of the roller frame 60. The baffle 92 and the holder plate 93 are arranged in parallel at the back side of the mounting portion 91. The holder plate 93 has two side edges serrated. The applicator element 100 is made of foamed material, sponge or the like that can pickup and retain paint for application. Further, the applicator element 100 is fastened to the holder plate 93 of the body 90.

The coupling hole 911 of the supplementary paint applicator 4 is coupled to the connecting area between the second part 62 and third part 63 of the roller frame 60, keeping the supplementary paint applicator 4 secured to the main paint roller 3 with the applicator element 100 and the baffle 92 disposed at one lateral side of the roller cover 80. When installed, the distance between the baffle 92 and the roller cover 80 is greater than the distance between the applicator element 100 and the roller cover 80.

The paint roller assembly G of the second preferred embodiment of the present invention is practical for painting the border area between two abutted wall surfaces, achieving the same effect as the aforesaid first preferred embodiment of the present invention.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A paint roller assembly comprising a main paint roller and a supplementary paint applicator;
wherein said main paint roller comprises a roller frame, a handle fastened to said roller frame, and a roller cover pivotally mounted on said roller frame for soaking and retaining paint and rotatable on said roller frame over a wall surface to apply retained paint to said wall surface;
wherein said supplementary paint applicator comprises a body having a mounting portion connectable to said roller frame of said main paint roller, and an applicator element fastened to said body and located at a lateral side of said roller cover of said main paint roller for soaking paint for application.

2. The paint roller assembly as claimed in claim 1, wherein said body of said supplementary paint applicator comprises a baffle; said applicator element is fastened to said body adjacent to one side of said baffle, and a distance between said baffle and said roller cover is greater than a distance between said applicator element and said roller cover.

3. The paint roller assembly as claimed in claim 2, wherein said roller frame comprises a base and two support arms symmetrically outwardly extended from said base, said support arms each having a free end terminating in an inwardly transversely extended bent and then a pivot; said roller cover has two coupling holes respectively formed on two distal ends thereof and respectively coupled to the pivots of said support arms of said roller frame; said handle is fastened to the base of said roller frame; said mounting portion of said supplementary paint applicator has a coupling hole fitting the bent of each of said support arms and connectable to the bend of one said support arm.

4. The paint roller assembly as claimed in claim 3, wherein roller cover comprises a roller cover body and a covering covered on a periphery of said roller cover body for soaking and retaining paint; said coupling holes are respectively formed on two distal ends of said roller cover body.

5. The paint roller assembly as claimed in claim 4, wherein said covering of said roller cover comprises an outer felt layer.

6. The paint roller assembly as claimed in claim 4, wherein said covering of said roller cover and said applicator element are respectively made of sponge.

7. The paint roller assembly as claimed in claim 4, wherein said covering of said roller cover and said applicator element are respectively made of a foamed material.

8. The paint roller assembly as claimed in claim 3, wherein said mounting portion has a front side and a back side, the coupling hole of said mounting portion of said supplementary paint applicator is formed on the front side of said mounting portion; said baffle is disposed at the back side of said mounting portion of said supplementary paint applicator.

9. The paint roller assembly as claimed in claim 8, wherein the body of said supplementary paint applicator comprises a holder plate disposed at the back side of said mounting portion for holding said applicator element.

10. The paint roller assembly as claimed in claim 1, wherein said roller frame of said main paint roller is formed of a metal wire rod by bending, having a first part, a second part integrally extended from one end of said first part and defining with said first part a contained angle, and a third part integrally extended from one end of said second part remote from said first part and defining with said second part a contained angle; said handle is fastened to the first part of said roller frame; said roller cover is pivotally mounted on the third part of said roller frame; said mounting portion of said supplementary paint applicator has a coupling hole fitting the connecting area between said second part and said third part of said roller frame and connectable to the connecting area between said second part and said third part of said roller frame.
